(19) United States
(12) Patent Application Publication
(10) Pub. No.: US 2010/0173791 A1
(43) Pub. Date: Jul. 8, 2010

(54) PROCESS DESIGN USING MASS SPECTROMETRY

(75) Inventor: Egisto Boschetti, Croissy-sur-Seine (FR)

Correspondence Address: MORGAN, LEWIS & BOCKIUS LLP (SF), One Market, Spear Street Tower, Suite 2800, San Francisco, CA, 94105, US

(73) Assignee: Bio-Rad Laboratories, Inc., Hercules, CA (US)

(21) Appl. No.: 12/651,942

(22) Filed: Jan. 4, 2010

Related U.S. Application Data
(60) Provisional application No. 61/142,546, filed on Jan. 5, 2009.

(51) Int. Cl. C40B 30/02; C40B 50/02; C40B 40/00

(52) U.S. Cl. 506/8; 506/24; 506/13

(57) ABSTRACT

The present invention provides a facile and efficient method for determining a chromatographic protocol for separating a target protein from one or more second protein impurity. Also provided is a database facilitating the determination of an appropriate separation protocol.

### CROSS-REFERENCE TO RELATED APPLICATIONS

This application claims the benefit of priority to U.S. Provisional Patent Application No. 61/142,546, filed Jan. 5, 2009, which is hereby incorporated in its entirety.

### BACKGROUND OF THE INVENTION

Various approaches are known for devising protein purification processes. Classical methods are based on a large number of chromatographic separations crossing over both different interaction mechanisms (various sorbents), and discrete changes in ionic strength, buffer composition and/or pH. Data analysis of separation profiles generated by this method requires intensive manual processing or the use of dedicated software. To discriminate among many separation alternatives, heuristics have been suggested; however, they rarely consider the composition and the variability of protein extracts. Calculation-based approaches have also been proposed to simulate the best conditions of separation involving thermodynamic equilibria and diffusion models. Unfortunately due to their high level of complexity calculation models are not widely implemented and remain of didactic interest.

With the advent of mass spectrometry for the purpose of biomarker discovery, complex biological systems need to be fractionated and their protein fraction purified for identification, pharmacological and toxicological investigation, and basic research. In this context, the above-mentioned methods are too labor-intensive, involving the optimization of complicated adsorption and elution steps with multiple buffers and multiple columns, requiring that even highly specialized technicians spend weeks if not months to develop an appropriate process.

More recently chromatographic surfaces for mass spectrometry analysis allowed for rapid generation of predictive data for elution chromatography. This included the identification of the type of sorbent and rough physicochemical conditions for the separation of a target protein from other analytical mixture components. Although this latter approach is of practical interest, it is restricted to the availability of functionalized mass spectrometry surfaces; such surfaces are available for only a very limited subset of chromatography media.

More recently, a new approach was reported based on a first simple selection of a few chromatographic resins from a large collection. In contrast to classical chromatographic methods, the main variable is the selection of a sequence of resins instead of a selection of adsorption and elution conditions. In practice, starting from a crude extract from which a target protein is to be purified, a selection of a first chromatographic medium is made based upon that medium's ability to capture a target protein, with simultaneous minimal capture of protein impurities. As a second step one or a few chromatographic media from the same collection are selected based upon their ability to capture most of the protein impurities, but not the target protein. Columns are packed with the selected chromatographic medium or media: a first column is packed with the chromatographic medium/media with selective affinity for the protein impurities; a second column is packed with the chromatographic medium/media selective for the target protein. The outlet of the first column is connected to the inlet of the second column filled with the medium able to capture the target protein. Then the sequence of columns is loaded with the crude extract. Once the loading and washing steps are completed, the columns are separated and the target protein eluted from the second column. This method suffers from a large number of time-consuming analyses of eluates and retentates.

A method for selecting chromatographic media in which the selection steps are augmented by automated analytical determinations, e.g., by mass spectrometry, high throughput electrophoresis, etc. would represent a significant advance in the fields of proteomics. Moreover, a methods that in which the analytical process is informed by reference to a database of chromatographic media correlated to target protein behavior on these media, would significantly simplify experimental design of multi-media chromatographic separations of proteins and other analytes.

### SUMMARY OF THE INVENTION

In various embodiments, the present invention provides a method of purifying a target analyte (e.g., a known target analyte) from a mixture containing the target and one or more unknown or known impurities, protein purification and analysis of the behavior of one or more molecule, e.g., a biomolecule, on one or more chromatographic medium. Exemplary applications of this embodiment lie in the fields of protein expression and purification, proteomics and protein interactions.

A proteome is defined as the totality of all the proteins of one cell type under precisely defined boundary conditions. Because higher life forms contain several hundred types of cells, there are also hundreds of proteomes. The proteome includes proteins that are common to all the cell types of the life-form (housekeeping proteins), and those that are specific to one type of cell. The proteome is also mutable, being modified both qualitatively and quantitatively with boundary conditions such as age, or stress on the cell community resulting e.g., from the exposure to environmental factors, e.g., from the administration of medication.

In various embodiments, the target protein is a structural or functional protein, a multimeric molecular complex or macromolecular assembly. Exemplary target proteins include enzymes, immunoglobulins, cell surface receptors and intracellular receptors.

In an exemplary embodiment, the present invention provides a simplified and improved method of isolating or concentrating a target protein, which is effective and is less time- and labor-intensive than currently practiced methods. Moreover, it is possible with the invention to find and to identify considerably more proteins in a mixture of proteins than is possible with the procedures in use so far.

In various exemplary embodiments, several chromatographic media for protein separation are packed into individual columns. In an exemplary embodiment, one or more chromatographic medium/media is functionalized with amino acids chemically immobilized on solid phase beads, likewise sorbents for affinity chromatography, are an exemplary starting point for assembling a collection of chromatographic media for use in purifying a target protein.

In an exemplary embodiment one aliquot of the crude extract (mixture), in which the target protein to separate is present, is injected into each individual column, for example, under pre-determined conditions of pH and of ionic strength (e.g., a physiological buffer). After extensive washing to eliminate proteins not captured, each column is eluted with a stripping solution (e.g., acidic urea added or not with a compatible detergent, e.g., CHAPS). Each eluate containing a protein captured by its respective chromatographic medium is submitted to a full LC/MS or LC/MS/MS analysis. In various embodiments, eluted proteins are electrophoretically separated, e.g., by SDS-PAGE. Each lane is sliced in multiple sections, e.g., into from about 10 to about 30, preferably from about 10 to about 20 parts. Each of these sections is treated with a degradative enzyme (e.g., trypsin to produce peptides). The peptides are then analyzed by a MS system, e.g., LTQ-Orbitrap. This analysis yields lists of proteins that are captured by each individual chromatographic medium. These lists indicate where the target protein is present or absent. Thus, the present invention in various embodiments provides a facile and versatile method for assembling a readily cross-referenceable database of chromatographic media and the analytes they bind and substances they do not bind.

The present invention also provides a method of determining a first chromatographic medium that captures a target protein from a mixture and a second chromatographic medium that captures a second protein component from the mixture. The method comprises querying the database of the invention with a criterion related to the structure of the target protein, the second protein component or a combination thereof. An exemplary criterion is a characteristic of one or more peptides resulting from a cryptic digest of one or more component of the mixture. An exemplary characteristic is selected from a molecular weight acquired by mass spectrometry, a mass spectrum of a portion thereof, and a liquid chromatographic retention time. Those of skill in the art will appreciate that the method of querying can utilize more than one criterion.

The invention also provides a method of selecting appropriate chromatographic media for effecting purification of an analyte. In an exemplary embodiment, the selection of chromatographic media for the purification of target analyte is made as follows: (a) select the chromatographic sorbent that captures the target analyte and a limited number of protein impurities; (b) select one or more chromatographic media that does not capture the target analyte, but which captures the largest number of impurities; (c) mix the chromatographic media selected for the capture of impurities and pack a first column; (d) pack a second column with the medium selected as being able to capture the target analyte and connect it at the outlet of the column containing the medium (or media), which capture the impurity(ies); apply the crude extract into the top column (the one capable of adsorbing impurities) so that the target analyte passes through and enters the second column where it is captured; (e) disconnect the second column and then desorb the target analyte, using a stripping buffer or using an optimized elution solution, thereby eluting a purified or concentrated fraction of the target analyte. The optimized solution can be designed for collecting the target protein while leaving potential co-captured protein impurities adsorbed on the media. In an exemplary embodiment, the analyte is a biomolecule, e.g., a protein.

In an exemplary embodiment, a large number of impurities are captured by the first column, while other impurities pass into the second column. A significant portion of the impurities passing into the second column is eliminated in the flowthrough. In many embodiments, a minimal number of other impurities are co-adsorbed on the chromatographic medium in the second column, which captures the target protein.

The method of the invention is highly versatile, allowing the use of a wide variety of chromatographic media including one or more binding functionality. In certain embodiments, the functionality is positively charged (anion exchange); negatively charged (cation exchange); a hydrophobic functionality (aromatic or aliphatic, short or long chain); a chelating agent, e.g., that can engage in coordinate covalent bonding with a metal ion; or a biospecific compound, e.g., an antibody or cellular receptor. In some embodiments, the functionality is a small molecule taken from, for example, from an amino acid group, from a nucleotide group, from a sugar group and all oligomers. Exemplary binding functionalities include without limitation, N,N,N-trimethylethanolammonium salt (e.g., chloride; strong anion exchange or “SAX”) N,N-dimethylethanolamine, N,N-dimethyloctylamine, N-methylglucamine (weak anion exchange or “WAX”), 3-mercaptopropane sulfonate (strong cation exchange or “SCX”), 3-mercaptopropionate, dimethyloacetic acid, dihydroxybenzoic acid, (weak cation exchange or “WCX”) or N,N-bis(carboxymethyl)-L-lysine or N-hydroxyethylethylenediaminoe-triacetic acid (NTA) (immobilized metal chelate or “IMAC”).

The present invention also provides a user-accessible, machine-readable database, and a method of assembling such a database. In various embodiments, the database is a relational database relating a member of a library of chromatographic media to a member of a protein library. The relationship may be any that allows for the efficient design of a process of the invention, including, but not limited to, the ability of a chromatographic medium to bind a target protein; the ability of a chromatographic medium to bind a protein impurity; a condition under which a target protein is captured by a chromatographic medium; a condition under which a captured target protein is eluted from a chromatographic medium; a condition under which a protein impurity is captured by a chromatographic medium; and a condition under which a captured protein impurity can be eluted from a chromatographic medium.

In various embodiments, the database is loaded onto a computer server to which computers can be connected, for example a portable or stationary personal computer. The data can be recorded on a data medium.

Other aspects, embodiments, objects and advantages of the present invention are set forth by way of example in the detailed description that follows.

### DESCRIPTION OF THE DRAWINGS

FIG. 1 is a diagram showing an exemplary design of a process of the invention. Crude extract is passed over a column containing one or more chromatographic medium, capturing protein from the extract. Proteins not captured by the column are collected in the flowthrough (FT). The method provides for linking any convenient number (n) of columns together or running the process in batch mode through each column individually.

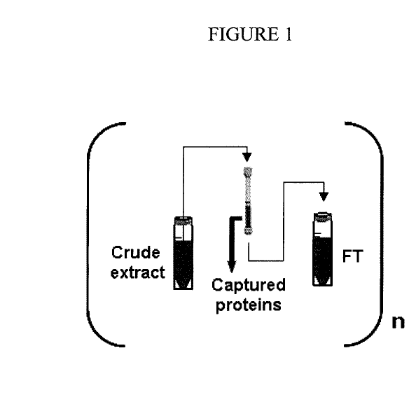

### DETAILED DESCRIPTION OF THE INVENTION AND THE PREFERRED EMBODIMENTS

### The Embodiments

### Introduction

As set forth hereinabove, the present invention provides a method for determining a chromatographic purification, concentration or enrichment (generally referred to herein as “purification”) protocol for a target analyte. The methods of the present invention can be used to identify a purification protocol for and to purify any target, or class of targets, which interact with a binding functionality on a chromatographic medium in a determinable manner. The interaction between the target and binding functionality can be any physicochemical interaction, including covalent bonding, ionic bonding, hydrogen bonding, van der Waals interactions, attractive electronic interactions and hydrophobic/hydrophilic interactions.

### The Methods

In various exemplary embodiments, several chromatographic media for protein separation are packed into individual columns. In an exemplary embodiment, one or more chromatographic medium/media is functionalized with amino acids chemically immobilized on solid phase beads, likewise sorbents for affinity chromatography, are an exemplary starting point for assembling a collection of chromatographic media for use in purifying a target protein.

In an exemplary embodiment one aliquot of the crude extract (mixture), in which the target protein to separate is present, is injected into each individual column, for example, under pre-determined conditions of pH and of ionic strength (e.g., a physiological buffer). After extensive washing to eliminate proteins not captured, each column is eluted with a stripping solution (e.g., acidic urea or alkaline urea added or not with a compatible detergent, e.g., CHAPS). Each eluate containing a protein is captured by their respective chromatographic medium is submitted to a full LCMS/MS analysis. In various embodiments, eluted proteins are electrophoretically separated, e.g., by SDS-PAGE.

Following chromatographic purification, the partial proteomes are then optionally subjected to degradative digestion, e.g., tryptic digestion, each of them giving rise to some thousands or tens of thousands of digestion peptides. “Tryptic” digestion is digestion by the enzyme trypsin, which specifically cuts each of the C-terminals of the two basic amino acids lysine and arginine. The digestion peptides have variable lengths (depending slightly on the statistical proportions of lysine and arginine in the proteome). The lengths have a Poisson distribution extending from one amino acid up to about 40 amino acids. The majority of peptides have a mass in the range of between 800 and 4000 atomic mass units, and these can effectively be measured by MALDI time-of-flight mass spectrometry. The digestion peptides cover the range between extreme hydrophilia and extreme hydrophobia relatively evenly. In an exemplary embodiment, the peptides in the digestion mixture are characterized by LC/MS or LC/MS/MS.

In various embodiments, as set forth above, eluted proteins are electrophoretically separated, e.g., by SDS-PAGE. Each lane is optionally sliced into multiple sections, e.g., from about 10 to about 20, preferably from about 10 to about 30 parts. Each of these sections is treated with a degradative enzyme (e.g., trypsin to produce peptides). The peptides are then analyzed by a MS system, e.g., LTQ-Orbitrap. This analysis yields lists of proteins that are captured by each individual column. Thus, the present invention in various embodiments provides a facile and versatile method for assembling a readily cross-referenceable database of chromatographic media and the analytes they bind and substances they do not bind.

In another embodiment the entire analytical process allows making lists of proteins and their respective behavior for each member of a media library from well-known cells or microorganisms (e.g. bacteria and yeasts). Protein lists associated with appropriate software provide a way to select the best media combination or sequence for the purification of one protein from the lists.

In various embodiments, the invention also provides a method of selecting appropriate chromatographic media for effecting purification of an analyte. In an exemplary embodiment, the selection of chromatographic media for the purification of target analyte is made as follows: (a) select the chromatographic sorbent that captures the target analyte and a limited number of protein impurities; (b) select one or more chromatographic media that do not capture the target analyte, but which capture the largest number of impurities; (c) mix the chromatographic media selected for the capture of impurities and pack a first column; (d) pack a second column with the medium selected as being able to capture the target analyte and connect it at the outlet of the column containing the medium (or media), which capture the impurity(ies); apply the crude extract into the top column (the one capable of adsorbing impurities) so that the target analyte passes through and enters the second column where it is captured; (e) disconnect the second column and then desorb the target analyte, using a stripping buffer or using an optimized solution, thereby eluting a purified or concentrated fraction of the target analyte. In an exemplary embodiment, the analyte is a biomolecule, e.g., a protein.

As will be recognized by those of skill in the art, the ability of any chromatographic medium to capture a particular target analyte is based on its mode of interaction with the analyte under well-defined conditions. In an exemplary embodiment, the present invention exploits and categorizes the binding affinity of different types of chromatography media for different types of target (and non-target) analytes by exposing an analyte mixture to chromatographic media having different modes of interaction, thereby separating components of a sample based upon their interaction with the different chromatographic media. Thus, the attraction of the analyte for chromatographic media having different modes of interaction provides a first separation parameter. For example, by exposing a sample containing the analyte (e.g., target protein) to a first chromatographic medium with a basis of attraction involving hydrophobicity and a second chromatographic medium with a basis of attraction involving ionic charge, it is possible to separate from the sample those analytes which bind to a hydrophobic chromatographic medium and to separate those analytes which bind to a chromatographic medium having the particular ionic charge.

The resolution of analytes upon the basis of attraction of the analyte for the chromatographic medium can be further refined by exploiting binding characteristics of relatively intermediate specificity or altered strength of attraction. Resolution of the analyte on the basis of binding characteristics of intermediate specificity can be accomplished, for example, by utilizing mixed functionality chromatographic media. Once the resolution of the analyte is accomplished with relatively low specificity, the binding characteristic found to attract the analyte of interest can be exploited in combination with a variety of other binding and elution characteristics to remove still more undesired components and thereby resolve the analyte.

For example, if the analyte binds to hydrophobic chromatographic media, the analyte can be further resolved from other hydrophobic sample components by providing a mixed functionality chromatographic medium which exhibits as one basis of attraction a hydrophobic interaction and also exhibits a second, different basis of attraction. The mixed functionality chromatographic medium may exhibit hydrophobic interactions and negatively charged ionic interactions so as to bind hydrophobic analytes which are positively charged. Alternatively, the mixed functionality chromatographic medium can exhibit hydrophobic interactions and the ability to form coordinate covalent bonds with metal ions so as to bind hydrophobic analytes having the ability to form coordination complexes with metal ions on the chromatographic medium. Still further examples of chromatographic media exhibiting binding characteristics of intermediate specificity will be readily apparent to those skilled in the art based upon the disclosure and examples set forth above.

The resolution of analytes on the basis of binding characteristics of intermediate specificity can be further refined by exploiting binding characteristics of relatively high specificity. Binding characteristics of relatively high specificity can be exploited by utilizing a variety of chromatographic media exhibiting the same basis of attraction but a different strength of attraction. In other words, although the basis of attraction is the same, further resolution of the analyte from other sample components can be achieved by utilizing chromatographic media having different degrees of affinity for the analyte.

For example, an analyte that binds a chromatographic medium based upon the analyte's acidic nature may be further resolved from other acidic sample components by utilizing chromatographic media having affinity for analytes in specific acidic pH ranges. Thus the analyte may be resolved using one chromatographic medium attracted to sample components of pH 1-2, another chromatographic medium attracted to sample components of pH of 3-4, and a third chromatographic medium attracted to sample components of pH of 5-6. In this manner, an analyte having a specific affinity for a chromatographic medium which binds analyte of, pH of 5-6 will be resolved from sample components of pH of 1-4. Chromatographic media of increasing specificity can be utilized by decreasing the interval of attraction, i.e., the difference between the binding characteristics of chromatographic media exhibiting the same basis of attraction.

Moreover, a primary analyte adsorbed to a primary chromatographic medium can, itself, have adsorbent properties. In this case, the primary analyte adsorbed to a substrate can become a secondary chromatographic medium for isolating secondary analytes. In turn, the retained secondary analyte can function as a tertiary chromatographic medium to isolate a tertiary analyte from a sample. This process can continue through several iterations.

### Chromatographic Media

A wide range of chromatography media can be employed in the method of the invention. Different chromatography media can exhibit markedly different binding characteristics, somewhat different binding characteristics, or subtly different binding characteristics. Chromatography media which exhibit markedly different binding characteristics typically differ in their bases of attraction or mode of interaction. The basis of attraction is generally a function of chemical or biological molecular recognition. Bases for attraction between an chromatography media of use in the present invention and an analyte (or impurity) include, for example, (1) a salt-promoted interaction, e.g., hydrophobic interactions, thiophilic interactions, and immobilized dye interactions; (2) hydrogen bonding and/or van der Waals forces interactions and charge transfer interactions, such as in the case of a hydrophilic interactions; (3) electrostatic interactions, such as an ionic charge interaction, particularly positive or negative ionic charge interactions; (4) the ability of the analyte to form coordinate covalent bonds (i.e., coordination complex formation) with a metal ion on the chromatographic medium; (5) enzyme-active site binding; (6) reversible covalent interactions, for example, disulfide exchange interactions; (7) glycoprotein interactions; (8) biospecific interactions; or (9) combinations of two or more of the foregoing modes of interaction. That is, the chromatographic medium can exhibit two or more bases of attraction, and thus be known as a “mixed functionality” chromatographic medium.

The present invention makes use of essentially any chromatographic media, regardless of its physical structure, support, or binding affinity as long as the binding affinity is appropriate for a particular application. The methods of the invention are not limited with respect to chromatographic media of use in practicing these methods. The moiety on a chromatographic medium forming a complex with an analyte (e.g., a target protein) or impurity (e.g., a second protein component) is referred to herein as a “binding functionality.”Though the present invention encompasses the use of chromatographic media functionalized with any binding functionality, non-limiting exemplars of useful binding functionalities are set forth hereinbelow.

In an exemplary embodiment, the chromatographic support is selected for use in a method that involves “capture” of an analyte. As used herein, the term “capture” refers to an interaction between a group on the chromatographic medium and a complementary group on an analyte. The interaction can be either reversible or irreversible. Molecules can be captured from a variety of milieus, including pure liquids, solutions, gases, vapors and the like. This embodiment of the invention can be used for a broad range of applications including, for example, chromatography (e.g., affinity, gas, ion exchange, reverse-phase, normal-phase), assays, proton sponges, catalysis, concentration of trace materials and the like. Further, the capturing can be an end in itself (e.g., removing a contaminant from a mixture) or it can be a step in a multi-step process (e.g., recovering an analyte from a mixture). An example of a method using capture is affinity chromatography.

One advantage of the invention is the ability to expose the analytes to a variety of different chromatography media, and binding and elution conditions, thereby providing both increased resolution of analytes and information about them in the form of a recognition profile. As in conventional chromatographic methods, the ability of the chromatographic medium to retain the analyte is directly related to the attraction or affinity of the analyte for the chromatographic medium as compared to the attraction or affinity of the analyte for the eluent or the eluent for the chromatographic medium. Some components of the sample may have no affinity for the chromatographic medium and therefore will not bind to the chromatographic medium when the sample mixture is contacted with the chromatographic medium. Due to their inability to bind to the chromatographic medium, these components will be immediately separated from the analyte to be resolved. However, depending upon the nature of the sample and the particular chromatographic medium utilized, a number of different components can initially bind to the chromatographic medium. Thus, in an exemplary embodiment, the invention provides a method in which chromatographic media are selected based upon their ability to capture a target analyte or impurities in a mixture.

### Binding Functionality

“Binding functionality,” or “analyte binding functionality,” as used herein means a moiety, which has an affinity for a certain substance such as a “target analyte,” that is, a moiety capable of interacting with a specific substance to immobilize it on a chromatographic medium. Binding functionalities can be chromatographic or biospecific. Chromatographic binding functionalities bind substances via charge-charge, hydrophilic-hydrophilic, hydrophobic-hydrophobic, van der Waals interactions and combinations thereof. Biospecific binding functionalities generally involve complementary 3-dimensional structures involving one or more of the above interactions. Examples of biospecific interactions include, but are not limited to, antigens with corresponding antibody molecules, a nucleic acid sequence with its complementary sequence, effector molecules with receptor molecules, enzymes with inhibitors, sugar chain-containing compounds with lectins, an antibody molecule with another antibody molecule specific for the former antibody, carrier proteins with the carried molecule, receptor molecules with corresponding antibody molecules and the like combinations. Other examples of the specific binding substances include a chemically biotin-modified antibody molecule or polynucleotide with avidin, an avidin-bound antibody molecule with biotin and the like combinations.

Binding functionalities can be chromatographic or biospecific. Chromatographic binding functionalities bind substances via charge-charge, hydrophilic-hydrophilic, hydrophobic-hydrophobic, van der Waals interactions and combinations thereof. Exemplary classes of binding functionalities of use in the present invention are set forth below.

The binding functionality can be a component of a small organic molecule with the ability to specifically recognize an analyte molecule. Exemplary small molecules include, but are not limited to, dyes, amino acids, biotins, avidin, streptavidin carbohydrates, glutathiones, nucleotides vitamins, sugars and synthetic enzyme inhibitors.

In another exemplary embodiment, the binding functionality is a biomolecule, e.g., a natural or synthetic peptide, antibody, nucleic acid, oligo (or poly)-saccharide, heparin, lectin, member of a receptor/ligand binding pair, antigen, cell or a combination thereof.

In another exemplary embodiment, the binding functionality is a drug moiety or a pharmacophore derived from a drug moiety. The drug moieties can be agents already accepted for clinical use or they can be drugs whose use is experimental, or whose activity or mechanism of action is under investigation. The drug moieties can have a proven action in a given disease state or can be only hypothesized to show desirable action in a given disease state. In various embodiments, the drug moiety binds with a target protein, immobilizing it on a chromatographic medium.

In an exemplary embodiment, a member selected from the first chromatographic medium and the second chromatographic medium includes a binding functionality that is selected from a positively charged moiety, a negatively charged moiety, an anion exchange moiety, a cation exchange moiety, a metal ion complexing moiety, a metal complex, a polar moiety, a hydrophobic moiety. Further exemplary binding functionalities include, biospecific binding functionalities, e.g., an amino acid, a dye, a carbohydrate, a nucleic acid, a peptide, a lipid (e.g., a phosphotidyl choline), an antibody, a ligand, and a receptor.

### Salt-promoted Interactions

Chromatographic media useful for observing salt-promoted interactions include hydrophobic interaction chromatographic media. Examples of hydrophobic interaction chromatographic media include matrices having aliphatic hydrocarbons, specifically C₁-C₁₈ aliphatic hydrocarbons; and matrices having aromatic hydrocarbon functional groups such as phenyl groups. Hydrophobic interaction chromatographic media bind analytes which include uncharged solvent exposed amino acid residues, and specifically amino acid residues which are commonly referred to as nonpolar, aromatic and hydrophobic amino acid residues, such as phenylalanine and tryptophan. Specific examples of analytes which will bind to a hydrophobic interaction chromatographic medium include lysozyme, antibodies and DNA.

### Hydrophilic Interaction Chromatographic Media

Chromatographic media which are useful for observing hydrogen bonding and/or van der Waals forces on the basis of hydrophilic interactions include surfaces comprising normal phase media such as silicon-oxide (i.e., glass). The normal phase or silicon-oxide surface, acts as a functional group. In addition, chromatographic media comprising surfaces modified with hydrophilic polymers such as polyethylene glycol, dextran, agarose, or cellulose can also function as hydrophilic interaction chromatographic media. Most proteins will bind hydrophilic interaction media because of a group or combination of amino acid residues (i.e., hydrophilic amino acid residues) that bind through hydrophilic interactions involving hydrogen bonding or van der Waals forces. Examples of proteins which will bind hydrophilic interaction media include myoglobin, insulin and cytochrome C.

In general, proteins with a high proportion of polar or charged amino acids will be retained on a hydrophilic surface. Alternatively, glycoproteins with surface exposed hydrophilic sugar moieties also have high affinity for hydrophilic chromatographic media.

### Electrostatic Interaction Chromatographic Media

Chromatographic media which are useful for observing electrostatic or ionic charge interactions include anionic chromatographic media such as, for example, matrices of sulfate anions and matrices of carboxylate anions or phosphate anions. Matrices having sulfate anions are permanent negatively charged.

Other chromatographic media which are useful for observing electrostatic or ionic charge interactions include cationic chromatographic media. Specific examples of cationic chromatographic media include matrices of secondary, tertiary or quaternary amines. Quaternary amines are permanently positively charged. However, secondary and tertiary amines have charges that are pH dependent.

In the case of ionic interaction chromatographic media (both anionic and cationic) it is often desirable to use a mixed mode ionic chromatographic medium containing both anions and cations. Such chromatographic media provide a continuous buffering capacity as a function of pH. The continuous buffering capacity enables the exposure of a combination of analytes to eluents having differing buffering components especially in the pH range of from 2 to 11. This results in the generation of local pH environments on the chromatographic medium which are defined by immobilized titratable proton exchange groups. Such systems are equivalent to the solid phase separation technique known as chromatofocusing. Follicle stimulating hormone isoforms, which differ mainly in the charged carbohydrate components, are separated on a chromatofocusing chromatographic medium.

Still other chromatographic media which are useful for observing electrostatic interactions include dipole-dipole interaction chromatographic media in which the interactions are electrostatic but no formal charge or titratable protein donor or acceptor is involved.

### Coordinate Covalent Interaction Chromatographic Media

Chromatographic media which are useful for observing the ability to form coordinate covalent bonds with metal ions include matrices bearing, for example, divalent and trivalent metal ions. Matrices of immobilized metal ion chelators provide immobilized synthetic organic molecules that have one or more electron donor groups which form the basis of coordinate covalent interactions with transition metal ions. The primary electron donor groups functioning as immobilized metal ion chelators include oxygen, nitrogen, and sulfur. The metal ions are bound to the immobilized metal ion chelators resulting in a metal ion complex having some number of remaining sites for interaction with electron donor groups on the analyte. Suitable metal ions include in general transition metal ions such as copper, nickel, cobalt, zinc, iron, and other metal ions such as aluminum and calcium. Without wishing to be bound by any particular theory, metals ions are believed to interact selectively with specific amino acid residues in peptides, proteins, or nucleic acids. Typically, the amino acid residues involved in such interactions include histidine residues, tyrosine residues, tryptophan residues, cysteine residues, and amino acid residues having oxygen groups such as aspartic acid and glutamic acid. For example, immobilized ferric ions interact with phosphoserine, phosphotyrosine, and phosphothreonine residues on proteins. Depending on the immobilized metal ion, only those proteins with sufficient local densities of the foregoing amino acid residues will be retained by the chromatographic medium. Some interactions between metal ions and proteins can be so strong that the protein cannot be severed from the complex by conventional means. Human β casein, which is highly phosphorylated, binds very strongly to immobilized Fe(III). Recombinant proteins which are expressed with a 6-Histidine tag, binds very strongly to immobilized Cu(II) and Ni(II).

### Enzyme-Active Site Interaction Chromatographic Media

Chromatographic media which are useful for observing enzyme-active site binding interactions include proteases (such as trypsin), phosphatases, kinases, and nucleases. The interaction is a sequence-specific interaction of the enzyme binding site on the analyte (typically a biopolymer) with the catalytic binding site on the enzyme. Enzyme binding sites of this type include, for example, active sites of trypsin interacting with proteins and peptides having lysine-lysine or lysine-arginine pairs in their sequence. More specifically, soybean trypsin inhibitor interacts with and binds to a chromatographic medium of immobilized trypsin. Alternatively, serine proteases are selectively retained on immobilized L-arginine chromatographic medium.

### Reversible Covalent Interaction Chromatographic Media

Chromatographic media which are useful for observing reversible covalent interactions include disulfide exchange interaction chromatographic media. Disulfide exchange interaction chromatographic media include chromatographic media comprising immobilized sulfhydryl groups, e.g., mercaptoethanol or immobilized dithiothrietol. The interaction is based upon the formation of covalent disulfide bonds between the chromatographic medium and solvent exposed cysteine residues on the analyte. Such chromatographic media bind proteins or peptides having cysteine residues and nucleic acids including bases modified to contain reduced sulfur compounds.

### Glycoprotein Interaction Chromatographic Media

Chromatographic media which are useful for observing glycoprotein interactions include glycoprotein interaction chromatographic media such as chromatographic media having immobilized lectins (i.e., proteins bearing oligosaccharides) thereon, an example of which is concanavalin A. Such chromatographic media function on the basis of the interaction involving molecular recognition of carbohydrate moieties on macromolecules. Examples of analytes which interact with and bind to glycoprotein interaction chromatographic media include glycoproteins, particularly histidine-rich glycoproteins, whole cells and isolated subcellular fractions.

### Biospecific Interaction Chromatographic Media

Chromatographic media which are useful for observing biospecific interactions are generically termed “biospecific affinity chromatographic media.” Adsorption is considered biospecific if it is selective and the affinity (equilibrium dissociation constant, K_{d}) is at least 10⁻³ M to (e.g., 10⁻⁵ M, 10⁻⁷ M, 10⁻⁹ M). Examples of biospecific affinity chromatographic media include any chromatographic medium which specifically interacts with and binds a particular biomolecule. Biospecific affinity chromatographic media include for example, immobilized antibodies which bind to antigens; immobilized DNA which binds to DNA binding proteins, DNA, and RNA; immobilized substrates or inhibitors which bind to proteins and enzymes; immobilized drugs which bind to drug binding proteins; immobilized ligands which bind to receptors; immobilized receptors which bind to ligands; immobilized RNA which binds to DNA and RNA binding proteins; immobilized avidin or streptavidin which bind biotin and biotinylated molecules; immobilized phospholipid membranes and vesicles which bind lipid-binding proteins. Enzymes are useful chromatographic media that can modify an analyte chromatographic medium thereto. Cells are useful as chromatographic media. Their surfaces present complex binding characteristics. Adsorption to cells is useful for identifying, e.g., ligands or signal molecules that bind to surface receptors. Viruses or phage also are useful as chromatographic media. Viruses frequently have ligands for cell surface receptors (e.g., gp120 for CD4). Also, in the form a phage display library, phage coat proteins act as agents for testing binding to targets. Biospecific interaction chromatographic media rely on known specific interactions such as those described above. Other examples of biospecific interactions for which chromatographic media can be utilized will be readily apparent to those skilled in the art and are contemplated by the present invention.

Biospecific binding functionalities generally involve complementary 3-dimensional structures involving one or more of the above interactions. Examples of combinations of biospecific interactions include, but are not limited to, antigens with corresponding antibody molecules, a nucleic acid sequence with its complementary sequence, effector molecules with receptor molecules, enzymes with inhibitors, sugar chain-containing compounds with lectins, an antibody molecule with another antibody molecule specific for the former antibody, receptor molecules with corresponding antibody molecules and the like combinations. Other examples of the specific binding substances include a chemically biotin-modified antibody molecule or polynucleotide with avidin, an avidin-bound antibody molecule with biotin and the like combinations.

### Eluents

“Eluent” or “wash solution” refers to an agent, typically a solution, which is used to affect or modify adsorption of an analyte to a chromatographic medium surface and/or remove unbound materials from the surface. The elution characteristics of an eluent can depend, for example, on pH, ionic strength, hydrophobicity, degree of chaotropism, detergent strength and temperature. In the discussion that follows, both “eluents” and “wash solutions” are discussed under the rubric of “eluents.” Those of skill in the art appreciate; however, that as used herein, these terms have a different meaning even in those circumstances when an eluent and a wash solution are of similar composition. An “eluent” refers to the solution used to remove a substance captured by a chromatographic material through interaction between the substance and a binding functionality of the chromatographic material. A “wash solution” refers to the solution utilized to wash an unbound or adventitiously bound substance (e.g., second protein component) from a chromatographic material.

The eluents selectively modify the threshold of absorption between the analyte and the chromatographic medium. The ability of an eluent to desorb and elute a bound analyte is a function of its elution characteristics. Different eluents can exhibit significantly different elution characteristics, somewhat different elution characteristics, or subtly different elution characteristics.

The temperature at which the eluent is contacted to the chromatographic medium is a function of the particular sample and chromatographic media selected. Typically, the eluent is contacted to the chromatographic medium at a temperature of between 0° C. and 100° C., preferably between 4° C. and 37° C. However, for some eluents, modified temperatures can be desirable and will be readily determinable by those skilled in the art.

As in the case of chromatographic media, eluents which exhibit significantly different elution characteristics generally differ in their mechanism of action. For example, various bases of attraction between the eluent and the analyte include charge or pH, ionic strength, water structure, concentrations of specific competitive binding reagents, surface tension, dielectric constant and combinations of two or more of the above.

pH-Based Eluents

Eluents which modify the selectivity of the chromatographic medium based upon pH (i.e., charge) include known pH buffers, acidic solutions, and basic solutions. By washing an analyte bound to a given chromatographic medium with a particular pH buffer, the charge can be modified and therefore the strength of the bond between the chromatographic medium and the analyte in the presence of the particular pH buffer can be altered. Those analytes which are less competitive than others for the chromatographic medium at the pH of the eluent will be desorbed from the chromatographic medium and eluted, leaving bound only those analytes which bind more strongly to the chromatographic medium at the pH of the eluent.

### Ionic Strength-Based Eluents

Eluents which modify the selectivity of the chromatographic medium with respect to ionic strength include salt solutions of various types and concentrations. The amount of salt solubilized in the eluent solution affects the ionic strength of the eluent and modifies the chromatographic medium binding ability correspondingly. Eluents containing a low concentration of salt provide a slight modification of the chromatographic medium binding ability with respect to ionic strength. Eluents containing a high concentration of salt provide a greater modification of the chromatographic medium binding ability with respect to ionic strength.

### Water Structure-Based Eluents

Eluents which modify the selectivity of the chromatographic medium by alteration of water structure or concentration include urea and chaotropic salt solutions. Typically, urea solutions include, e.g., solutions ranging in concentration from 0.1 to 8 M. Chaotropic salts which can be used to provide eluents include sodium thiocyanate and guanidine hydrochloride. Water structure-based eluents modify the ability of the chromatographic medium to bind the analyte due to alterations in hydration or bound water structure. Eluents of this type include for example, glycerol, ethylene glycol and organic solvents. Chaotropic anions increase the water solubility of nonpolar moieties thereby decreasing hydrophobic interactions between the analyte and the chromatographic medium.

### Detergent-Based Eluents

Eluents which modify the selectivity of the chromatographic medium with respect to surface tension and analyte structure include detergents and surfactants. Suitable detergents for use as eluents include ionic and nonionic detergents such as CHAPS, TWEEN and NP-40. Detergent-based eluents modify the ability of the chromatographic medium to bind the analyte as the hydrophobic interactions are modified when the hydrophobic and hydrophilic groups of the detergent are introduced. Hydrophobic interactions between the analyte and the chromatographic medium, and within the analyte are modified and charge groups are introduced, e.g., protein denaturation with ionic detergents such as SDS.

### Hydrophobicity-Based Eluents

Eluents which modify the selectivity of the chromatographic medium with respect to dielectric constant are those eluents which modify the selectivity of the chromatographic medium with respect to hydrophobic interaction. Examples of suitable eluents which function in this capacity include urea (e.g., 0.18 M) organic solvents such as propanol, acetonitrile, ethylene glycol and glycerol, and detergents such as those mentioned above. Use of acetonitrile as eluent is typical in reverse phase chromatography. Inclusion of ethylene glycol in the eluent is effective in eluting immunoglobulins from salt-promoted interactions with thiophilic chromatographic media.

### Competition Eluents

Eluents which compete with either the media functionality or the analyte to displace the latter are competition eluents. In one non-limiting exemplary embodiment, sugars can be used as competition eluents when glycoproteins are captured by lectin media. Such eluents would specifically displace the analyte (i.e., the glycoprotein).

Suitable eluents can be selected from any of the foregoing categories or can be combinations of two or more of the foregoing eluents. Eluents which comprise two or more of the foregoing eluents are capable of modifying the selectivity of the chromatographic medium for the analyte on the basis of multiple elution characteristics.

After the chromatographic medium is contacted with the analyte (or impurity), resulting in the binding of the analyte to the chromatographic medium, the chromatographic medium is washed with eluent. Washing with the eluents modifies the analyte (or impurity) population retained on a specified chromatographic medium. The combination of the binding characteristics of the chromatographic medium and the elution characteristics of the eluent provide the selectivity conditions which control the analytes retained by the chromatographic medium after washing. Thus, the washing step selectively removes components from the chromatographic medium.

The washing step can be carried out using a variety of techniques. For example, as seen above, the sample can be solubilized in or admixed with the first eluent prior to contacting the sample to the chromatographic medium. Exposing the sample to the first eluent prior to or simultaneously with contacting the sample to the chromatographic medium has, to a first approximation, the same net effect as binding the analyte to the chromatographic medium and subsequently washing the chromatographic medium with the first eluent. After the combined solution is contacted to the chromatographic medium, the chromatographic medium can be washed with the second or subsequent eluents.

Washing a chromatographic medium having the analyte bound thereto can be accomplished by bathing, soaking, or dipping the substrate having the chromatographic medium and analyte bound thereon in an eluent; or by rinsing, spraying, or washing over the substrate with the eluent. The introduction of eluent to small diameter spots of affinity reagent is best achieved by a microfluidics process.

### Analytes

“Analyte” refers to any component of a sample that is desired to be detected. The term can refer to a single component or a plurality of components in the sample. Analytes include, for example, biomolecules. Biomolecules can be sourced from any biological material. An exemplary analyte according to the methods of the invention is a “target protein,” referring to a protein which is to be purified and/or identified. Exemplary analytes are derived from biological material

“Biomolecule” or “bioorganic molecule” refers to an organic molecule typically made by living organisms. This includes, for example, molecules comprising nucleotides, amino acids, sugars, fatty acids, steroids, nucleic acids, polypeptides, peptides, peptide fragments, carbohydrates, lipids, and combinations of these (e.g., glycoproteins, ribonucleoproteins, lipoproteins, or the like). In various embodiments of the invention, a biological material is an analyte. In exemplary embodiments, the analyte is in a mixture of biological material, from which the analyte is purified according to the methods of the invention.

“Biological material” refers to any material derived from an organism, organ, tissue, cell or virus. This includes biological fluids such as saliva, blood, urine, lymphatic fluid, prostatic or seminal fluid, milk, etc., as well as extracts of any of these, e.g., cell extracts or lysates (from, e.g., primary tissue or cells, cultured tissue or cells, normal tissue or cells, diseased tissue or cells, benign tissue or cells, cancerous tissue or cells, salivary glandular tissue or cells, intestinal tissue or cells, neural tissue or cells, renal tissue or cells, lymphatic tissue or cells, bladder tissue or cells, prostatic tissue or cells, urogenital tissues or cells, tumoral tissue or cells, tumoral neovasculature tissue or cells, or the like), cell culture media, fractionated samples (e.g., serum or plasma), or the like. For example, cell lysate samples are optionally derived.

In various embodiments, the target analyte is a biomolecule such as a polypeptide (e.g., peptide or protein), a polynucleotide (e.g., oligonucleotide or nucleic acid), a carbohydrate (e.g., simple or complex carbohydrate) or a lipid (e.g., fatty acid or polyglycerides, phospholipids, etc.). In the case of proteins, the selection of an appropriate chromatographic medium generally depends upon the nature of the target protein. For example, one can capture a ligand using a receptor for the ligand as a binding functionality; an antigen using an antibody against the antigen; or a substrate using an enzyme that acts on the substrate.

The target can be derived from a biological source, including body fluids such as blood, serum, saliva, urine, seminal fluid, seminal plasma, lymph, and the like. It also can be derived from extracts from biological samples, such as cell lysates, cell culture media, or the like. For example, cell lysate samples are optionally derived from, e.g., primary tissue or cells, cultured tissue or cells, normal tissue or cells, diseased tissue or cells, benign tissue or cells, cancerous tissue or cells, salivary glandular tissue or cells, intestinal tissue or cells, neural tissue or cells, renal tissue or cells, lymphatic tissue or cells, bladder tissue or cells, prostatic tissue or cells, urogenital tissues or cells, tumoral tissue or cells, tumoral neovasculature tissue or cells, or the like.

The target can be labeled with a fluorophore or other detectable group either directly or indirectly through interacting with a second species to which a detectable group is bound. When a second labeled species is used as an indirect labeling agent, it is selected from any species that is known to interact with the target species. Preferred second labeled species include, but are not limited to, antibodies, aptazymes, aptamers, streptavidin, and biotin.

The target can be labeled either before or after it interacts with the binding functionality. The target molecule can be labeled with a detectable group or more than one detectable group. Where the target species is multiply labeled with more than one detectable group, the groups are preferably distinguishable from each other. Properties on the basis of which the individual detectable groups can be distinguished include, but are not limited to, fluorescence wavelength, absorption wavelength, fluorescence emission, fluorescence absorption, ultraviolet light absorbance, visible light absorbance, fluorescence quantum yield, fluorescence lifetime, light scattering and combinations thereof.

### Informatics

As high-resolution, high-sensitivity datasets acquired using the methods of the invention become available to the art, significant progress in the areas of diagnostics, therapeutics, drug development, biosensor development, and other related areas will occur. For example, disease markers can be identified and utilized for better confirmation of a disease condition or stage (see, U.S. Pat. Nos. 5,672,480; 5,599,677; 5,939,533; and 5,710,007). Methods for the rapid identification, isolation and/or purification of such markers are highly desirable. The present invention provides data (and databases containing such data) relevant to chromatographic processes of use in the identification, isolation and/or purification of proteins, including biomarkers, e.g., disease markers.

Thus, in another preferred embodiment, the present invention provides a database that includes at least one set of data. The data contained in the database is acquired using a method of the invention. The database can be in substantially any form in which data can be maintained and transmitted, but is preferably an electronic database. The electronic database of the invention can be maintained on any electronic device allowing for the storage of and access to the database, such as a personal computer, but is preferably distributed on a wide area network, such as the World Wide Web.

The methods described herein for identifying and/or quantitating the relative and/or absolute abundance of a variety of molecular and macromolecular species from a biological sample provide an abundance of information, which can be correlated with a number of different characteristics of interest including, but not limited to, pathological conditions, predisposition to disease, drug testing, therapeutic monitoring, gene-disease causal linkages, identification of correlates of immunity and physiological status, among others. Although the data generated from the methods of the invention are suited for manual review and analysis, in a preferred embodiment, data processing and access to the database makes use of high-speed computers.

In an exemplary embodiment, the invention provides a method of preparing a machine readable, user accessible database comprising LC/MS/MS data acquired from a chromatographic purification protocol for a target protein. The method includes: (a) applying to “m” different first chromatographic media a mixture comprising the target protein and a second protein component (protein impurities) under conditions suitable to form (m-a) target protein-first chromatographic media complexes. The index “m” is an integer from 1 to 100. The index “a” is an integer from 0 to 99, and “m” and “a” are independently selected such that (m-a) is greater than or equal to 0. In an exemplary embodiment, “a” refers to a number of protein mixtures that do not include a component forming a complex with the first chromatographic medium (e.g., proteins not bound to or which are adventitiously, rather than specifically bound, to the chromatographic medium).

In step (b), following step (a), each of the “m” different first chromatographic media is washed under conditions appropriate to remove the second protein component from at least one of the m different chromatographic media. In step (c), following step (b), each of the m different chromatographic media is treated under conditions appropriate to elute the target protein from at least one of the (m-a) different target protein-first chromatographic medium complexes. In step (d), m different eluent fractions are collected from the eluting. In step (e), proteins in the eluent fractions are detected and, preferably, identified by one or more methods. In various embodiments, the detection is effected by acquiring LC/MS or LC/MS/MS after whole trypsin digestion or trypsin digestion after SDS-PAGE fractionation. In an exemplary embodiment, data from each of the m different eluent fractions determine the protein composition as a list of gene products. In various embodiments, the method is utilized to determine a member selected from; (i) amount of the target protein eluted from each of the m different first chromatographic media; (ii) amount of the second protein component washed from each of the chromatographic media; (iii) identity of the second protein component; and (iv) a combination thereof.

In step (f), data from step (e) is utilized to select a first chromatographic medium binding the target protein, preferably, the first chromatographic medium binding the lowest number of protein impurities from the m different first chromatographic media.

A similar process is followed to construct a database of chromatographic media binding a second protein component. For example, in step (g), a mixture comprising the second protein component (and optionally, the target protein) is applied to n different second chromatographic media under conditions suitable to form (n-b) second protein component-second chromatographic media complexes. The index n is an integer from 1 to 100. The index b is an integer from 0 to 99, and m and a are independently selected such that (n-b) is greater than or equal to 0. In exemplary embodiments, “b” refers to a number of protein mixtures that do not include a component forming a complex with the second chromatographic medium (e.g., proteins not bound to or which are adventitiously, rather than specifically bound, to the chromatographic medium). In a preferred embodiment, one protein component that does not bind to the second chromatographic medium is the target protein.

In step (h), following step (g), each of the n different second protein-second chromatographic media complexes is washed under conditions appropriate to remove the target protein from least one of the n different second chromatographic media. In step (i), n different wash fractions are collected from the washing, at least one of the n different eluent fractions comprising the second protein component. The protein content of at least one of the wash fractions is analyzed by an art recognized method. In various embodiments, the detection is effected by acquiring LC/MS or LC/MS/MS after whole trypsin digestion or trypsin digestion after SDS-PAGE fractionation. Step (j) involves collecting data from the method. In an exemplary embodiment, data from each of the n different eluent fractions determine the protein composition as a list of gene products. In various embodiments, the method is utilized to determine a member selected from; (i) amount of the second protein eluted from each of the n different second chromatographic media; (ii) amount of the second protein component washed from each of the second chromatographic media; (iii) identity of the second protein component; and (iv) a combination thereof. In step (k), data from step (j) is utilized to select a second chromatographic medium binding the second protein component from the n different second chromatographic media.

The data from steps (e) and (j) is stored in a machine readable, user accessible format, thereby preparing a database of the invention.

In an exemplary embodiment, the second protein component is a protein impurity. In various embodiments, the second protein component is one member of a plurality of protein impurities.

In various embodiments, the invention provides a method for creating a machine-readable, user-accessible database which facilitates selection of at least a first chromatographic medium and a second chromatographic medium suitable for a chromatographic separation of a target protein and a second protein component from a mixture. The method includes: (a) selecting a plurality of a first chromatographic medium and a plurality of a second chromatographic medium; (b) contacting each member of the plurality of the first chromatographic medium and each member of the plurality of a second chromatographic medium with the mixture under conditions appropriate to form at least one target protein-first chromatographic medium complex, and at least one second protein component-second chromatographic medium complex; (c) analyzing, by an analytical method, a member selected from a wash solution, an eluent and a combination thereof isolated from each member of the plurality of a first chromatographic medium and each member of the plurality of a second chromatographic medium; (d) assigning a result of the analysis according to (c) to the first chromatographic medium and the second chromatographic medium in the database, this result characterizing different protein components within a member selected from the wash solution, the eluent and a combination thereof, the database being a relational database comprising: (i) a first entity in which is recorded information relating to the target protein; (ii) a second entity comprising information relating to the second protein component; (iii) a third entity in which is recorded information relating to the first chromatographic medium; (iv) a fourth entity in which is recorded information relating to the second chromatographic medium; and (v) at least one fifth entity in which is recorded information related to a result of the analysis according to (c).

In various embodiments, the invention provides a method for creating a machine-readable, user accessible database facilitating selection of at least one chromatographic medium suitable for separating a target protein from a second protein component in a mixture. the method includes: (a) preparing a plurality of different chromatography media each comprising a different binding moiety; (b) contacting each member of the plurality of different chromatographic media with the mixture under conditions suitable to immobilize through the binding moiety a member selected from the target protein, the second protein component and a combination thereof; (c) contacting each of the plurality of chromatographic media of (b) with at least one solution suitable to elute a member selected from the target protein, the second protein component and a combination thereof from at least one of the plurality of chromatographic media; (d) analyzing, by an analytical method, each eluent formed in (c); (e) assigning a result of the analysis according to (d) to the each of the plurality of chromatography media in the database, this result characterizing the various eluents formed in (c).

In exemplary embodiments, the database prepared by a method of the invention includes information related to the influence of structure of the first chromatographic medium on retention of a member selected from the target protein, the second protein component and a combination thereof by the first chromatographic medium. In various embodiments, the database prepared by a method of the invention includes information related to the influence of structure of the second chromatographic medium on retention of the target protein, the second protein component and a combination thereof by the second chromatographic medium. As will be apparent to those of skill in the art, exemplary databases prepared by a method of the invention include both of the above-noted types of information.

As discussed above, any type of chromatographic medium appropriate for a particular type of separation is of use in the methods of the invention, and data relevant to this chromatographic medium can be an entry in a database produced by a method of the invention. For example, in an exemplary method of the invention, the plurality of the first chromatographic media comprises at least two different chromatographic media comprising different binding moieties. In an exemplary embodiment, the plurality of the second chromatographic media comprises at least two different chromatographic media comprising different binding moieties. As will be appreciated by those of skill both the pluralities of both the first and second chromatographic media can include multiple binding functionalities of different structure. Moreover, a database of the invention can include data on such multiple structures.

The analytical data regarding the content of the eluent and wash fractions can be acquired from any useful modality. In various exemplary embodiments, the data is acquired from a method selected from liquid chromatography, mass spectrometry and a combination thereof. In an exemplary embodiment, the analytical method is LC/MS or LC/MS/MS.

The database of the invention also optionally includes data acquired from at least one chromatography medium, from which a file is generated collating the results generated for a plurality of chromatographic separations of the mixture using the chromatography medium. In an exemplary embodiment, for at least one chromatography medium from each of the first chromatographic medium and the second chromatographic medium, a file is generated collating the results generated for a plurality of chromatographic separations of the mixture using the first chromatography medium and the second chromatography medium.

In an exemplary embodiment, the present invention provides a user-accessible, machine readable database prepared by a method of the invention.

The invention also provides a method of selecting a chromatographic separation protocol for a mixture comprising a target protein. The method includes, (a) identifying the target protein; (b) identifying the second protein component; (c) querying a database of the invention to identify the first chromatographic medium and the second chromatographic medium.

In various embodiments, the invention accomplishes the objective of aiding the selection of a chromatographic medium by applying to the database a software inquiry system which poses a series of predetermined questions to an operator regarding his or her gas purification requirements and from the step-by-step answers elicited from the operator selects the various components which when combined will be an optimized chromatographic medium for the operator's specific process.

An array of methods for indexing and retrieving biomolecular information is known in the art. For example, U.S. Pat. Nos. 6,023,659 and 5,966,712 disclose a relational database system for storing biomolecular sequence information in a manner that allows sequences to be catalogued and searched according to one or more protein function hierarchies. U.S. Pat. No. 5,953,727 discloses a relational database having sequence records containing information in a format that allows a collection of partial-length DNA sequences to be catalogued and searched according to association with one or more sequencing projects for obtaining full-length sequences from the collection of partial length sequences. U.S. Pat. No. 5,706,498 discloses a gene database retrieval system for making a retrieval of a gene sequence similar to a sequence data item in a gene database based on the degree of similarity between a key sequence and a target sequence. U.S. Pat. No. 5,538,897 discloses a method using mass spectroscopy fragmentation patterns of peptides to identify amino acid sequences in computer databases by comparison of predicted mass spectra with experimentally-derived mass spectra using a closeness-of-fit measure. U.S. Pat. No. 5,926,818 discloses a multidimensional database comprising a functionality for multi-dimensional data analysis described as on-line analytical processing (OLAP), which entails the consolidation of projected and actual data according to more than one consolidation path or dimension. U.S. Pat. No. 5,295,261 reports a hybrid database structure in which the fields of each database record are divided into two classes, navigational and informational data, with navigational fields stored in a hierarchical topological map which can be viewed as a tree structure or as the merger of two or more such tree structures.

Moreover, there are a number of different relational database software programs available commercially (for example, from Oracle, Tripos, MDL, Oxford Molecular (“Chemical Design”), IDBS (“Activity Base”)), and other software vendors. which are capable of presenting a user (i.e., the operator) with a series of structured, predetermined questions and a list of acceptable answers for each question, and from the answer selected by the user for each question be able to search the database and select information (e.g., a chromatographic medium) which are most responsive to the user's answers.

Relational database software is a preferred type of software for managing the data obtained during the processes described herein. This type of software is well known to those of skill in the art. The specific descriptions and details, of such software therefore do not need to be described in detail in this specification. In an exemplary embodiment, the user, having logged on to the software/database system of the present invention, will simply encounter a series of interactive screens or Web site pages which pose the applicable questions seriatim and use the answers individually or in combination to retrieve from the database identification of the components which, when combined, will result in the specification of gas purification equipment which will provide overall optimum performance in the system specified by the operator in response to the interactive questions from the software.

The present invention provides a computer database comprising a computer and software for storing in computer-retrievable form purification data records (e.g., chromatographic media) cross-tabulated, for example, with data specifying the source, sequence or structure of the target or the target-containing sample from which each record was obtained.

In an exemplary embodiment, at least one source of target-containing sample is a tissue sample known to be free of pathological disorders. In a variation, at least one of the sources is a known pathological tissue specimen, for example, a neoplastic lesion or a tissue specimen containing a pathogen such as a virus, bacteria or the like. In another variation, the assay records cross-tabulate one or more of the following parameters for each target species in a sample: (1) a unique identification code, which can include, for example, a target molecular structure and/or characteristic separation coordinate (e.g., electrophoretic coordinates); (2) sample source; and (3) absolute and/or relative quantity of the target species present in the sample, in an eluent fraction or in a wash fraction.

The invention also provides for the storage and retrieval of a collection of target data in a computer data storage apparatus, which can include magnetic disks, optical disks, magneto-optical disks, DRAM, SRAM, SGRAM, SDRAM, RDRAM, DDR RAM, magnetic bubble memory devices, and other data storage devices, including CPU registers and on-CPU data storage arrays. Typically, the target data records are stored as a bit pattern in an array of magnetic domains on a magnetizable medium or as an array of charge states or transistor gate states, such as an array of cells in a DRAM device (e.g., each cell comprised of a transistor and a charge storage area, which may be on the transistor). In one embodiment, the invention provides such storage devices, and computer systems built therewith, comprising a bit pattern encoding a protein expression fingerprint record comprising unique identifiers for at least 10 target data records cross-tabulated with target source.

When the target is a peptide or nucleic acid, the invention optionally provides a method for identifying related peptide or nucleic acid sequences, comprising performing a computerized comparison between a peptide or nucleic acid sequence assay record stored in or retrieved from a computer storage device or database and at least one other sequence. The comparison can include a sequence analysis or comparison algorithm or computer program embodiment thereof (e.g., FASTA, TFASTA, GAP, BESTFIT) and/or the comparison may be of the relative amount of a peptide or nucleic acid sequence in a pool of sequences determined from a polypeptide or nucleic acid sample of a specimen.

The “SwissProt™” database from GeneBio (Geneva Bioinformatics S.A.), Geneva, which is always kept up to date, can, for instance, be used as the protein sequence library for the target proteins. There are, however, also other databases that can be used here, such as the NCBInr database from the National Institute of Health, USA, that contains genome data in addition to the protein data. The “Mascot™” program from Matrix Science Ltd., London, may be mentioned as a search engine, but here again there are a number of comparable search engines on the market. The search can be carried out over the internet, or within the organization (by intranet) if the database and the weekly database updates have been downloaded onto a local server (following the conclusion of appropriate contracts).

The invention also preferably provides a magnetic disk, such as an IBM-compatible (DOS, Windows, Windows95/98/2000, Windows NT, OS/2) or other format (e.g., Linux, SunOS, Solaris, AIX, SCO Unix, VMS, MV, Macintosh, etc.) floppy diskette or hard (fixed, Winchester) disk drive, comprising a bit pattern encoding data from an assay of the invention in a file format suitable for retrieval and processing in a computerized sequence analysis, comparison, or relative quantitation method.

The invention also provides a network, comprising a plurality of computing devices linked via a data link, such as an Ethernet cable (coax or 10BaseT), telephone line, ISDN line, wireless network, optical fiber, or other suitable signal transmission medium, whereby at least one network device (e.g., computer, disk array, etc.) comprises a pattern of magnetic domains (e.g., magnetic disk) and/or charge domains (e.g., an array of DRAM cells) composing a bit pattern encoding data acquired from an assay of the invention.

The invention also provides a method for transmitting assay data that includes generating an electronic signal on an electronic communications device, such as a modem, ISDN terminal adapter, DSL, cable modem, ATM switch, or the like, wherein the signal includes (in native or encrypted format) a bit pattern encoding data from an assay or a database comprising a plurality of assay results obtained by the method of the invention.

In a preferred embodiment, the invention provides a computer system for comparing a query target to a database containing an array of data structures, such as an assay result obtained by the method of the invention, and ranking database targets based on the degree of identity and gap weight to the target data. A central processor is preferably initialized to load and execute the computer program for alignment and/or comparison of the assay results. Data for a query target is entered into the central processor via an I/O device. Execution of the computer program results in the central processor retrieving the assay data from the data file, which comprises a binary description of an assay result.

The target data or record and the computer program can be transferred to secondary memory, which is typically random access memory (e.g., DRAM, SRAM, SGRAM, or SDRAM). Targets are ranked according to the degree of correspondence between a selected assay characteristic (e.g., binding to a selected binding functionality) and the same characteristic of the query target and results are output via an I/O device. For example, a central processor can be a conventional computer (e.g., Intel Pentium, PowerPC, Alpha, PA-8000, SPARC, MIPS 4400, MIPS 10000, VAX, etc.); a program can be a commercial or public domain molecular biology software package (e.g., UWGCG Sequence Analysis Software, Darwin); a data file can be an optical or magnetic disk, a data server, a memory device (e.g., DRAM, SRAM, SGRAM, SDRAM, EPROM, bubble memory, flash memory, etc.); an I/O device can be a terminal comprising a video display and a keyboard, a modem, an ISDN terminal adapter, an Ethernet port, a punched card reader, a magnetic strip reader, or other suitable I/O device.

The invention also preferably provides the use of a computer system, such as that described above, which comprises: (1) a computer; (2) a stored bit pattern encoding a collection of peptide sequence specificity records obtained by the methods of the invention, which may be stored in the computer; (3) a comparison target, such as a query target; and (4) a program for alignment and comparison, typically with rank-ordering of comparison results on the basis of computed similarity values.

### EXAMPLES

### Example 1

15 different amino acids were chemically attached to chromatographic beads to obtain 15 different affinity chromatography media. Each of them was packed in a different column and equilibrated with 0.5 M neutral sodium chloride. In each column independently an aliquot of red blood cell lysate was injected. Once all non-adsorbed proteins were eliminated in the flowthrough, proteins captured from each column were stripped using a concentrated urea acidified solution (stripping solution is 8M urea containing 2% CHAPS and 50 mM citric acid). Collected protein fractions were then submitted to SDS-PAGE separation. Each migration lane was cut in 17 equal slices along the migration path and each of them was digested with trypsin after reduction and alkylation. Peptides were then analysed by LC-MS/MS (LTQ Orbitrap) for protein identification in each sample (details of the fractionation and identifications can be found in Anal. Chem. 80, 2008, 3557-3565).

Lists of proteins from each column eluate were then made. Some amino acids captured large number of proteins, others captures smaller number. Some amino acids captured exclusively a certain number of proteins; many other proteins overlapped partially between one amino acid and another. From these lists the target protein to purify was identified as GTP-Binding nuclear protein Ran (IP100643041 with a mass of 24423 Da).

An exemplary process according to the present invention was as follows:

1. A list of amino acid columns capturing the target protein (along with a number of other proteins) was made. Amino acids were: arginine, asparagine, aspartic acid, glycine, histidine, isoleucine, lysine, proline, serine, threonine, tryptophane, tyrosine and valine.
2. The amino acid the least number of proteins was identified; in this example, aspartic acid.
3. A selection of amino acids that did not capture the target protein was made; in this example, phenylalanine and glutamine.
4. When Phe and Glu chromatographic media were mixed, they were able to capture 663 protein species out of a total of 799 from the initial crude extract. In the flowthrough, 136 proteins are captured, including the target protein.
5. The flowthrough injected in the aspartic acid column results in the capture of 7 different proteins (including the target protein), leaving uncaptured in the flowthrough 129 protein species.
6. Stripping out captured proteins (target and six other impurities together), the calculated purification factor of the target protein is 113 (7/799=113).

### Example 2

Example 2 provides a table with an exemplary calculated purification, a measure of which is provided by purification factor, of two exemplary proteins.

| Target proteins → | IPI-00183781 | IPI-00012578 |
|---|---|---|
| MW | 12417 | 57887 |
| Media blend for | Asn + Asp + Gln + Gly + | Tyr + Trp + Val |
| capturing impurities | Pro + Ser + Thr + Tyr + | |
| | Trp + Val | |
| Target protein column | Lysine | Glutamine |
| Purification factor | 43 | 45 |

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A method of preparing a machine readable, user accessible database comprising LC/MS/MS data acquired from a chromatographic purification protocol for a target protein, said method comprising:
(a) applying to m different first chromatographic media a mixture comprising said target protein and a second protein component under conditions suitable to form (m-a) target protein-first chromatographic media complexes
wherein
m is an integer from 1 to 100;
a is an integer from 0 to 99, and m and a are independently selected such that (m-a) is greater than or equal to 0;
(b) following step (a) washing each of said m different first chromatographic media under conditions appropriate to remove said second protein component from at least one of said m different chromatographic media;
(c) following step (b), treating each of said m different chromatographic media under conditions appropriate to elute said target protein from at least one of said (m-a) different target protein-first chromatographic medium complexes;
(d) collecting m different eluent fractions from said eluting;
(e) acquiring LC/MS/MS data from each of said m different eluent fractions, thereby determining a member selected from; (i) amount of said target protein eluted from each of said m different first chromatographic media; (ii) amount of said second protein component washed from each of said chromatographic media; (iii) identity of said second protein component; and (iv) a combination thereof;
(f) using data from step (e) to select a first chromatographic medium binding said target protein from said m different first chromatographic media;
(g) applying to n different second chromatographic media a mixture comprising said target protein and said second protein component under conditions suitable to form (n-b) second protein component-second chromatographic media complexes
wherein
n is an integer from 1 to 100;
b is an integer from 0 to 99, and m and a are independently selected such that (n-b) is greater than or equal to 0
(h) following step (g), washing each of said n different second protein-second chromatographic media complexes under conditions appropriate to remove said target protein from least one of said n different second chromatographic media;
(i) collecting n different wash fractions from said washing, at least one of said n different eluent fractions comprising said second protein component;
(j) acquiring LC/MS/MS data from each of said n different wash fractions, thereby determining a member selected from; (i) amount of said second protein component captured by each of said n different first chromatographic media; (ii) amount of said target protein component captured by each of said chromatographic media; (iii) identity of said second protein component and (iv) a combination thereof;
(k) using data from step (j) to select a second chromatographic medium binding said second protein component from said n different second chromatographic media; and
(l) storing data from steps (e) and (j) in a machine readable, user accessible format, thereby preparing said database.

2. A database prepared by the method according to claim 1.

3. A method of selecting a chromatographic separation protocol for a mixture comprising a target protein, said method comprising:
(a) identifying said target protein;
(b) identifying said second protein component;
(c) querying said database according to claim 2 to identify said first chromatographic medium and said second chromatographic medium.

4. A method for creating a machine-readable, user-accessible database which facilitates selection of at least a first chromatographic medium and a second chromatographic medium suitable for a chromatographic separation of a target protein and a second protein component from a mixture, said method comprising:
(a) selecting a plurality of a first chromatographic medium and a plurality of a second chromatographic medium;
(b) contacting each member of said plurality of said first chromatographic medium and each member of said plurality of a second chromatographic medium with said mixture under conditions appropriate to form at least one target protein-first chromatographic medium complex, and at least one second protein component-second chromatographic medium complex;
(c) analyzing, by an analytical method, a member selected from a wash solution, an eluent and a combination thereof isolated from each member of said plurality of a first chromatographic medium and each member of said plurality of a second chromatographic medium;
(d) assigning a result of the analysis according to (c) to said first chromatographic medium and said second chromatographic medium in said database, this result characterizing different protein components within a member selected from said wash solution, said eluent and a combination thereof, the database being a relational database comprising:
(i) a first entity in which is recorded information relating to said target protein;
(ii) a second entity comprising information relating to said second protein component;
(iii) a third entity in which is recorded information relating to said first chromatographic medium;
(iv) a fourth entity in which is recorded information relating to said second chromatographic medium; and
(v) at least one fifth entity in which is recorded information related to a result of the analysis according to (c).

5. The method of claim 4, wherein said database comprises information related to the influence of structure of said first chromatographic medium on retention of a member selected from said target protein, said second protein component and a combination thereof by said first chromatographic medium.

6. The method of claim 4, wherein said database comprises information related to the influence of structure of said second chromatographic medium on retention of said target protein, said second protein component and a combination thereof by said second chromatographic medium.

7. The method of claim 4 wherein said plurality of said first chromatographic media comprises at least two different chromatographic media comprising different binding moieties.

8. The method of claim 4 wherein said plurality of said second chromatographic media comprises at least two different chromatographic media comprising different binding moieties.

9. The method of claim 4, wherein said analytical method is a method selected from liquid chromatography, mass spectrometry and a combination thereof.

10. The method of claim 9, wherein said analytical method is LC/MS/MS.

11. The method of claim 4, wherein for at least one chromatography medium, a file is generated collating the results generated for a plurality of chromatographic separations of said mixture using said chromatography medium.

12. The method of claim 11, wherein, for at least one chromatography medium from each of said first chromatographic medium and said second chromatographic medium, a file is generated collating the results generated for a plurality of chromatographic separations of said mixture using said first chromatography medium and said second chromatography medium.

13. A method of selecting a chromatographic separation protocol for a mixture comprising a target protein, said method comprising:
(a) identifying said target protein;
(b) identifying said second protein component;
(c) querying said database according to claim 4 to identify said first chromatographic medium and said second chromatographic medium.

14. A method for creating a machine-readable, user accessible database facilitating selection of at least one chromatographic medium suitable for separating a target protein from a second protein component in a mixture, said method comprising:
(a) preparing a plurality of different chromatography media each comprising a different binding moiety;
(b) contacting each member of said plurality of different chromatographic media with said mixture under conditions suitable to immobilize through said binding moiety a member selected from said target protein, said second protein component and a combination thereof;
(c) contacting each of said plurality of chromatographic media of (b) with at least one solution suitable to elute a member selected from said target protein, said second protein component and a combination thereof from at least one of said plurality of chromatographic media;
(d) analyzing, by an analytical method, each eluent formed in (c);
(e) assigning a result of the analysis according to (d) to the each of said plurality of chromatography media in the database, this result characterizing the various eluents formed in (c).

15. The method of claim 14, wherein said analytical method is a method selected from liquid chromatography, mass spectrometry and a combination thereof.

16. The method of claim 15, wherein said analytical method is LC/MS/MS.

17. A method of selecting a chromatographic separation protocol for a mixture comprising a target protein, said method comprising:
(a) identifying said target protein;
(b) identifying said second protein component;
(c) querying said database according to claim 14 to identify said first chromatographic medium and said second chromatographic medium.
